(19) United States
(12) Patent Application Publication
(10) Pub. No.: US 2025/0130327 A1
(43) Pub. Date: Apr. 24, 2025

(54) WIFI-BASED MULTI-ROOM PRESENCE DETECTION

(71) Applicant: Samsung Electronics Co., Ltd., Suwon-si (KR)

(72) Inventors: Lianjun Li, McKinney, TX (US); Han Wang, Allen, TX (US); Hao Chen, Allen, TX (US); Wei Sun, Allen, TX (US); Satvir S. Bhatia, Sunnyvale, CA (US); Andrea M. Small, San Francisco, CA (US); Russell Douglas Ford, Campbell, CA (US)

(21) Appl. No.: 18/898,486

(22) Filed: Sep. 26, 2024

Related U.S. Application Data
(60) Provisional application No. 63/544,737, filed on Oct. 18, 2023.

(51) Int. Cl. G01S 13/56; H04W 84/12

(52) U.S. Cl. CPC G01S 13/56; H04W 84/12

(57) ABSTRACT

Methods and systems for user presence detection using wireless technology. A computer-implemented method includes receiving one or more data signals from at least one WiFi-node-to-Access-Point (AP) link or at least one WiFi-node-to-node link, performing a signal pre-processing process on the one or more data signals to generate one or more pre-processed data signals, performing the signal pre-processing process including performing a uniform sampling process, a power normalization process, an anomaly sample removal process, and a filtering process, extracting one or more features using the one or more pre-processed data signals, and using the one or more features to determine whether a user is present in the home and identify a specific room in which the user is located.

### CROSS-REFERENCE TO RELATED APPLICATIONS AND CLAIM OF PRIORITY

The present application claims priority to U.S. Provisional Patent Application No. 63/544,737, filed on Oct. 18, 2023. The contents of the above-identified patent documents are incorporated herein by reference.

### TECHNICAL FIELD

The present disclosure relates generally to wireless communication systems. More specifically, the present disclosure relates to a system and method for user presence detection using wireless technology.

### BACKGROUND

The Internet of Things (IoT) refers to a network of physical devices, such as vehicles, appliances, and other devices, that are embedded with sensors, software, and network connectivity, allowing them to collect and share data. Such a network may perform user presence detection to perform ambient intelligence use cases, such as wellness care, home energy preservation, entertainment, and home security processes. While radar-based presence detection systems may be used, these systems require additional equipment to function, increasing system complexity and cost.

Accordingly, there is a need for systems and methods for improved user presence detection that overcome these challenges.

### SUMMARY

The present disclosure relates generally to wireless communication systems and, more specifically, the present disclosure relates to a system and method for user presence detection using wireless technology.

In one embodiment, a computer-implemented method is provided. The computer-implemented method includes receiving one or more data signals from at least one WiFi-node-to-Access-Point (AP) link or at least one WiFi-node-to-node link, performing a signal pre-processing process on the one or more data signals to generate one or more pre-processed data signals. The signal pre-processing process includes performing a uniform sampling process, a power normalization process, an anomaly sample removal process, and a filtering process. The computer-implemented method further includes extracting one or more features using the one or more pre-processed data signals and using the one or more features to determine whether a user is present in a defined area.

In another embodiment, a presence detection system is provided. The user presence detection system includes one or more transceivers, and a hub including a processor. The processor configured to cause the hub to receive one or more data signals from at least one WiFi-node-to-Access-Point (AP) link or at least one WiFi-node-to-node link and perform a signal pre-processing process on the one or more data signals to generate one or more pre-processed data signals. The pre-processing process includes performing a uniform sampling process, a power normalization process, an anomaly sample removal process, and a filtering process. The processor is further configured to cause the hub to extract one or more features using the one or more pre-processed data signals and use the one or more features to determine whether a user is present in a defined area.

In yet another embodiment, a non-transitory computer-readable medium is provided. The non-transitory computer-readable medium includes program code, that when executed by at least one processor of an electronic device, causes the electronic device to receive one or more data signals from at least one WiFi-node-to-Access-Point (AP) link or at least one WiFi-node-to-node link and performing a signal pre-processing process on the one or more data signals to generate one or more pre-processed data signals. The pre-processing process includes performing a uniform sampling process, a power normalization process, an anomaly sample removal process, and a filtering process. The non-transitory computer-readable medium includes program code, that when executed by at least one processor of an electronic device, further causes the electronic device to extract one or more features using the one or more pre-processed data signals and use the one or more features to determine whether a user is present in a defined area.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to various embodiments of the present disclosure;

FIG. 2A illustrates an example access point according to various embodiments of the present disclosure;

FIG. 2B illustrates an example station according to various embodiments of this disclosure;

FIG. 3A illustrates an example wireless communication system performing user presence detection of a subject in an environment according to various embodiments of the present disclosure;

FIG. 3B illustrates an example schematic view of the example wireless communication system of FIG. 3A, according to various embodiments of the present disclosure;

FIG. 4 illustrates a flow chart of an example method for user presence detection using channel state information according to various embodiments of the present disclosure;

FIG. 5 illustrates a flow chart of an example signal processing method for processing a channel state information signal according to various embodiments of the present disclosure;

FIG. 6 illustrates a flow chart of an example method for extracting features from a channel state information signal according to various embodiments of the present disclosure;

FIG. 7A illustrates a flow chart of an example method for detecting a presence of a user using an artificial intelligence model according to various embodiments of the present disclosure; and

FIG. 7B illustrates a flow chart of an example method for detecting a presence of a user using a rule-based algorithm according to various embodiments of the present disclosure.

### DETAILED DESCRIPTION

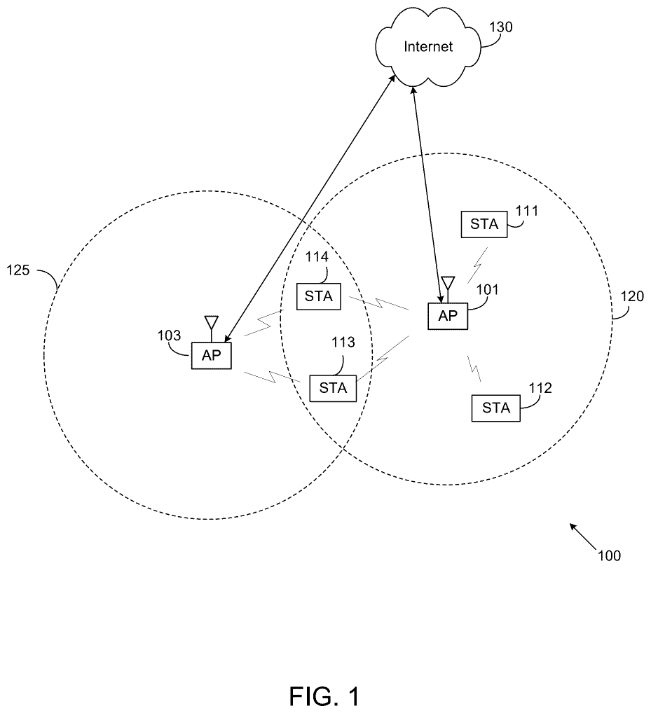

FIG. 1 through FIG. 7B, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

As introduced above, user presence detection in a system allows for localization of a subject to enable IoT and smart home applications in addition to wellness care, home energy preservation, entertainment, and home security applications. Although radar-based systems may determine the presence of a user, e.g., using additional sensors and equipment, the radar-based systems are often expensive and increase the complexity of the smart home.

Accordingly, the present disclosure provides systems and methods for wireless user presence detection. As described herein, the present disclosure includes a user presence detection system that includes a plurality of nodes and an electronic device, such as a hub, that receives data signals from each link in the system and determines the presence of a user in a specific room of a link-room map. The present disclosure may also use commodity WiFi, which is commonly available and, thus, does not involve new deployment costs.

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes access points (APs) 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using WI-FI or other WLAN communication techniques.

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming for detecting a user presence based on multi-antenna WiFi signals in WLANs. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101-103 could communicate directly with the network 130 and provide STAs with direct wireless broadband access to the network 130. Further, the APs 101 and/or 103 could provide access to other or additional external networks, such as external telephone networks or other types of data networks.

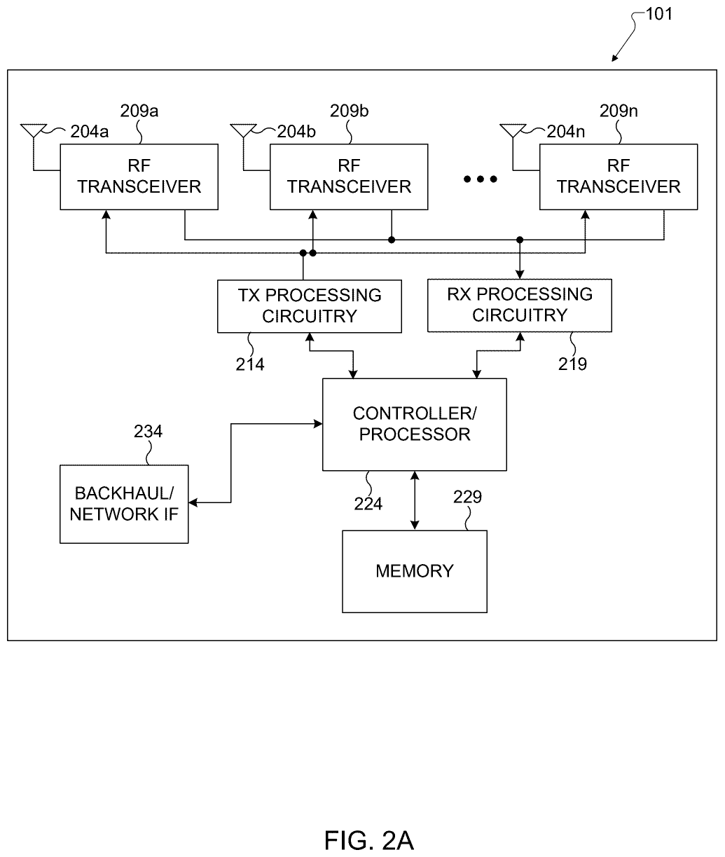

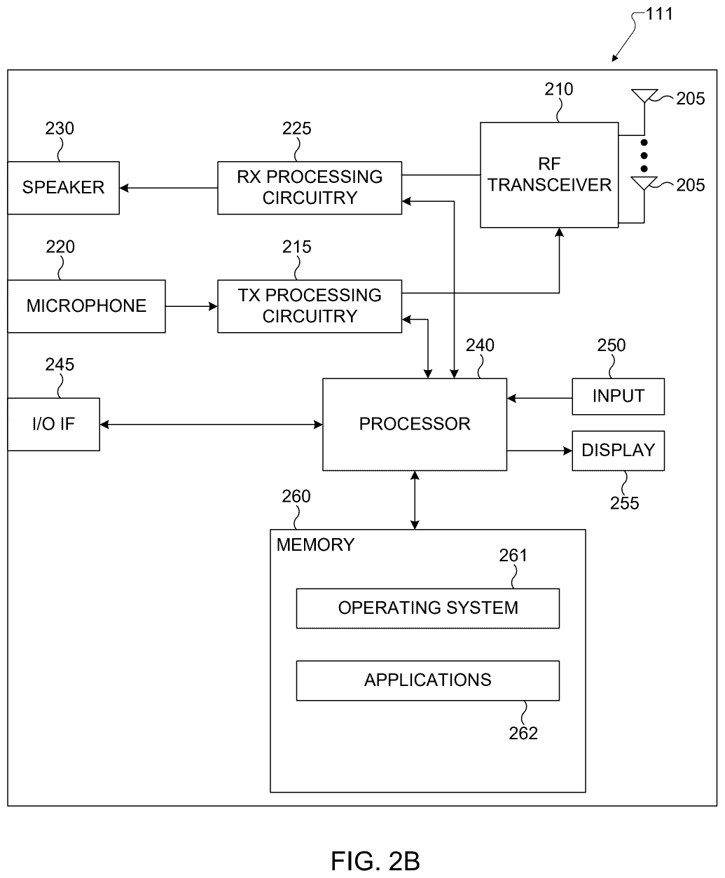

FIG. 2A illustrates an example AP 101 according to various embodiments of the present disclosure. The embodiment of the AP 101 illustrated in FIG. 2A is for illustration only, and the AP 103 of FIG. 1 could have the same or similar configuration. However, APs come in a wide variety of configurations, and FIG. 2A does not limit the scope of this disclosure to any particular implementation of an AP.

The AP 101 includes multiple antennas 204a-204n, multiple RF transceivers 209a-209n, transmitter processing circuitry 214, and receiver processing circuitry 219. The AP 101 also includes a controller/processor 224, a memory 229, and a backhaul or network interface 234. The RF transceivers 209a-209n receive, from the antennas 204a-204n, incoming RF signals, such as signals transmitted by STAs in the network 100. The RF transceivers 209a-209n down-convert the incoming RF signals to generate IF or baseband signals. The IF or baseband signals are sent to the receiver processing circuitry 219, which generates processed baseband signals by filtering, decoding, and/or digitizing the baseband or IF signals. The receiver processing circuitry 219 transmits the processed baseband signals to the controller/processor 224 for further processing.

The transmitter processing circuitry 214 receives analog or digital data (such as voice data, web data, e-mail, or interactive video game data) from the controller/processor 224. The transmitter processing circuitry 214 encodes, multiplexes, and/or digitizes the outgoing baseband data to generate processed baseband or IF signals. The RF transceivers 209a-209n receive the outgoing processed baseband or IF signals from the transmitter processing circuitry 214 and up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of forward channel signals and the transmission of reverse channel signals by the RF transceivers 209a-209n, the receiver processing circuitry 219, and the transmitter processing circuitry 214 in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including detecting a user presence based on multi-antenna WiFi signals. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for detecting a user presence based on multi-antenna WiFi signals. Although FIG. 2A illustrates one example of AP 101, various changes may be made to FIG. 2A. For example, the AP 101 could include any number of each component shown in FIG. 2A. As a particular example, an access point could include a number of interfaces 234, and the controller/processor 224 could support routing functions to route data between different network addresses. As another particular example, while shown as including a single instance of transmitter processing circuitry 214 and a single instance of receiver processing circuitry 219, the AP 101 could include multiple instances of each (such as one per RF transceiver). Alternatively, only one antenna and RF transceiver path may be included, such as in legacy APs. Also, various components in FIG. 2A could be combined, further subdivided, or omitted and additional components could be added according to particular needs.

FIG. 2B illustrates an example STA 111 according to various embodiments of this disclosure. The embodiment of the STA 111 illustrated in FIG. 2B is for illustration only, and the STAs 111-115 of FIG. 1 could have the same or similar configuration. However, STAs come in a wide variety of configurations, and FIG. 2B does not limit the scope of this disclosure to any particular implementation of a STA.

The STA 111 includes antenna(s) 205, a radio frequency (RF) transceiver 210, transmitter processing circuitry 215, a microphone 220, and receiver processing circuitry 225. The STA 111 also includes a speaker 230, a controller/processor 240, an input/output (I/O) interface (IF) 245, a touchscreen 250, a display 255, and a memory 260. The memory 260 includes an operating system (OS) 261 and one or more applications 262.

The RF transceiver 210 receives, from the antenna(s) 205, an incoming RF signal transmitted by an AP of the network 100. The RF transceiver 210 down-converts the incoming RF signal to generate an intermediate frequency (IF) or baseband signal. The IF or baseband signal is sent to the receiver processing circuitry 225, which generates a processed baseband signal by filtering, decoding, and/or digitizing the baseband or IF signal. The receiver processing circuitry 225 transmits the processed baseband signal to the speaker 230 (such as for voice data) or to the controller/processor 240 for further processing (such as for web browsing data).

The transmitter processing circuitry 215 receives analog or digital voice data from the microphone 220 or other outgoing baseband data (such as web data, e-mail, or interactive video game data) from the controller/processor 240. The transmitter processing circuitry 215 encodes, multiplexes, and/or digitizes the outgoing baseband data to generate a processed baseband or IF signal. The RF transceiver 210 receives the outgoing processed baseband or IF signal from the transmitter processing circuitry 215 and up-converts the baseband or IF signal to an RF signal that is transmitted via the antenna(s) 205.

The controller/processor 240 can include one or more processors and execute the basic OS program 261 stored in the memory 260 in order to control the overall operation of the STA 111. In one such operation, the controller/processor 240 controls the reception of forward channel signals and the transmission of reverse channel signals by the RF transceiver 210, the receiver processing circuitry 225, and the transmitter processing circuitry 215 in accordance with well-known principles. The controller/processor 240 can also include processing circuitry configured for detecting a user presence based on multi-antenna WiFi signals. In some embodiments, the controller/processor 240 includes at least one microprocessor or microcontroller.

The controller/processor 240 is also capable of executing other processes and programs resident in the memory 260, such as operations for detecting a user presence based on multi-antenna WiFi signals. The controller/processor 240 can move data into or out of the memory 260 as required by an executing process. In some embodiments, the controller/processor 240 is configured to execute a plurality of applications 262, such as applications for jointly detecting a user presence based on multi-antenna WiFi signals. The controller/processor 240 can operate the plurality of applications 262 based on the OS program 261 or in response to a signal received from an AP. The controller/processor 240 is also coupled to the I/O interface 245, which provides STA 111 with the ability to connect to other devices such as laptop computers and handheld computers. The I/O interface 245 is the communication path between these accessories and the controller 240.

The controller/processor 240 is also coupled to the touchscreen 250 and the display 255. The operator of the STA 111 can use the touchscreen 250 to enter data into the STA 111. The display 255 may be a liquid crystal display, light emitting diode display, or other display capable of rendering text and/or at least limited graphics, such as from web sites. The memory 260 is coupled to the controller/processor 240. Part of the memory 260 could include a random access memory (RAM), and another part of the memory 260 could include a Flash memory or other read-only memory (ROM).

Although FIG. 2B illustrates one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the controller/processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

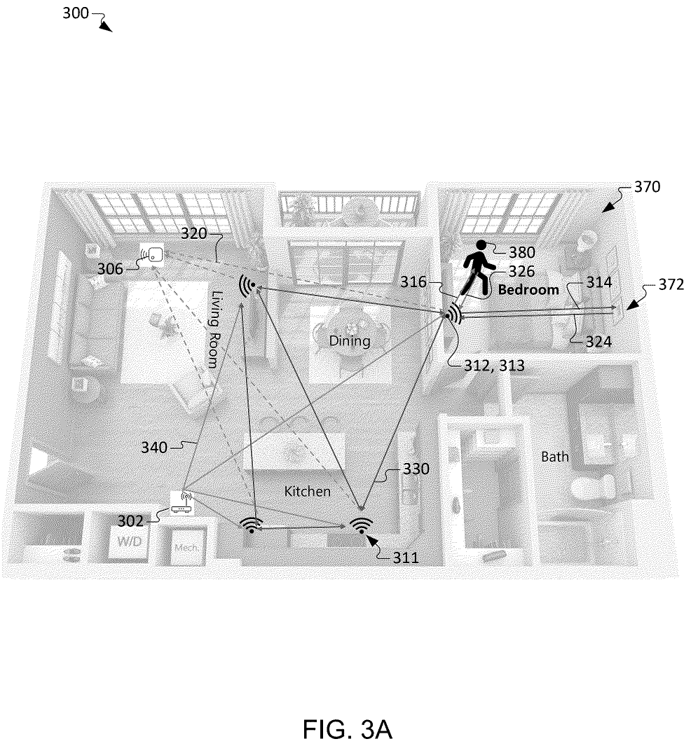

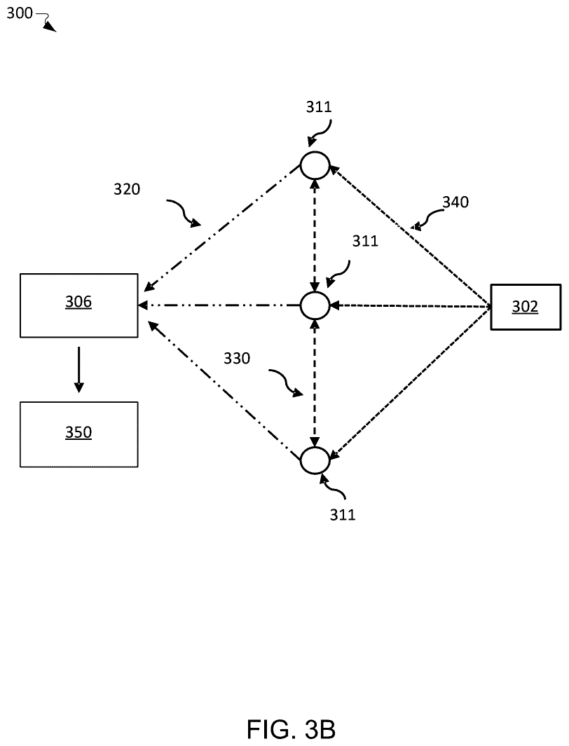

FIG. 3A illustrates an example wireless communication system 300 performing user presence detection of a subject 380 in an environment according to various embodiments of the present disclosure. FIG. 3B illustrates an example schematic diagram of the example wireless communication system 300 of FIG. 3A, according to various embodiments of the present disclosure.

As shown in FIG. 3A and FIG. 3B, the wireless communication system 300 includes an AP 302, one or more STAs 311, and a hub 306 (e.g., a smart hub) disposed in a defined area 370 and the wireless communication system 300 performs user presence estimation to determine the presence of the subject 380 located in the defined area 370. As used herein, the defined area may be, for example, without limitation, a home, business, campus, building, apartment, a particular room, living area, or building within the home, business, or campus, or a combination thereof. The embodiment of the wireless communication system 300 shown in FIG. 3A and FIG. 3B is for illustration only, and other embodiments could be used without departing from the scope of this disclosure. For example, the embodiment of the wireless communication system 300 shown in FIG. 3A and FIG. 3B could have the same or similar configuration as the network 100 of FIG. 1. The AP 302 and STA 311 of FIG. 3A and FIG. 3B can have the same or similar configuration as the AP 101 of FIG. 2A and the STA 111 of FIG. 2B, respectively.

For simplicity, commodity Wi-Fi infrastructure can refer to the AP 302, the STA 311, or the wireless communication system 300 that includes both the AP 302 and the STA 311. The commodity Wi-Fi infrastructure may be modern WiFi devices equipped with multiple antenna elements.

The one or more STAs 311, e.g., low-cost WiFi-compliant devices or nodes, are placed across rooms of a home as sensors and are connected to a home WiFi network through the WiFi access point, e.g., the AP 302. The one or more STAs 311 may be standalone WiFi nodes or WiFi modules integrated into home appliances. The one or more STAs 311 measure channel metrics, such as channel state information (CSI), of the wireless system 300. The hub 306, which is connected to the AP 302 and the one or more STAs 311, receives and processes one or more data signals 320 320, e.g., the measured channel metrics, from the one or more STAs 311. The one or more data signals 320 correspond to data signals from at least one WiFi node-to-AP link 340, at least one WiFi node-to-AP link 340, or a combination thereof.

As shown in FIG. 3B, the system diagram 300 includes the AP 302, the one or more STAs 311, and the hub 306. The AP 302 maintains the communication network between the one or more STAs 311 and the hub 306. The one or more STAs 311 measure node-to-node link 330, as well as node-to-AP link 340, channels metrics periodically. For example, the measurement metrics may include channel state information (CSI) and received signal strength indicator (RSSI) for each link. The one or more STAs 311 send the measured metrics from each link to the hub 306 in real-time. The hub 306 receives the measured metrics and generates a detection result 350.

The main features of a commodity Wi-Fi infrastructure, e.g., the wireless system 300, according to embodiments of this disclosure include obtaining measured metrics, e.g., CSI data, from multi-antenna commodity Wi-Fi infrastructure to estimate a user presence of the subject 380 using the hub 306 based on a system model that is configured to detect the presence of the subject 380.

As an example, the subject 380, whose presence will be detected, is in the vicinity of one of the one or more STAs 311. In the scenario shown, AP 302 transmits to each of the one or more STA 311 (as transceivers) and the one or more STAs 311 may emit signals, e.g., a first signal 314 and a second signal 316, which may contain data, such as a CSI frame. Some of the transmitted signals reflect off a stationary surface of object in the defined area 370, such as a ceiling, wall, floor, or furniture. For example, the signal 314 transmitted by a first transmitter 312 of the one or more STAs 311 reflects off a wall 372. As a result, a first receiver 313 receives a first reflected signal 324. Some of the transmitted signals reflect off a surface of the subject 380 in the defined area 370, such as the torso of a person. For example, the signals 316 transmitted by the first transmitter 312 is incident upon the surface of the subject 380 at an angle relative the subject 380. As a result, the first receiver 313 receives different reflected signals, e.g., a second reflected signal 326.

Although the example wireless communication system 300 is shown to be configured for WiFi, other configurations of wireless transmission technology are contemplated, including ultra-wideband, short-range wireless technology such as Bluetooth, impulse radio, 5G-NR, and audio transmissions. The hub 306 may maintain an association with the AP 302 and the one or more of the STAs 311 to initiate and supervise the task of presence detection. The hub 306 includes a processor (not shown) that can include one or more processors or other processing devices that control the overall operation of the hub 306 and may perform the methods provided herein. The hub 306 can be a separate device such as a personal computation device or can physically be a part of one of the STAs 311. In another embodiment, the transmission and receiving roles may be switched between the AP 302 and the one or more STAs 311, e.g., when the AP 302 or the STAs 311 are transceiver devices, over time as instructed by the hub 306.

Although FIG. 3 illustrates an example defined area 370 within which a wireless communication system 300 estimates a user presence of the subject 380, various changes may be made to FIG. 3. Particularly, the presence of a single subject 380 is for simplicity and ease of explanation only, but is not a limitation on the embodiments presented in this disclosure. For example, multiple subject 380s 380 may be present in the environment, and the wireless communication system 300 can detect the presence of each of the subject 380s 380. As another particular example, in one embodiment the transmitter can be an AP and the receiver can be a WiFi STA, or vice versa in another embodiment.

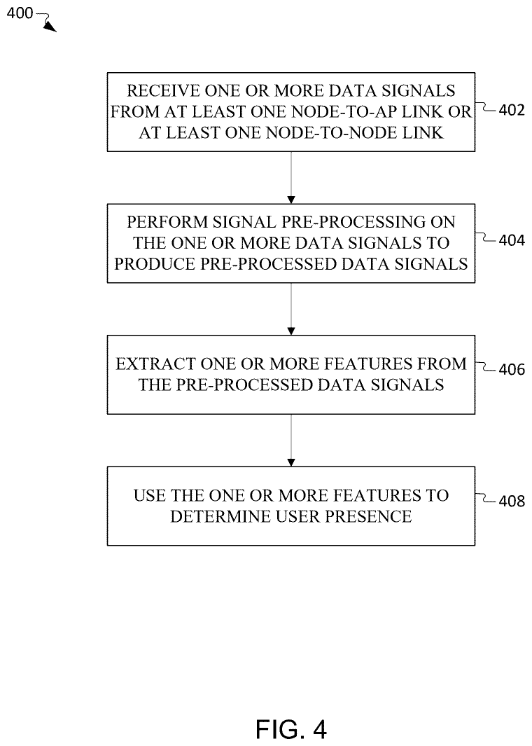

FIG. 4 illustrates a flow chart of an example method for user presence detection using channel state information according to various embodiments of the present disclosure. In particular, the method 400 may be performed by a hub, such as the hub 306 of FIG. 3A, for user presence detection in an environment, e.g., the defined area 370 of FIG. 3A.

In operation 402, one or more data signals 320 from at least one WiFi node-to-AP link 340 or at least one WiFi node-to-node link 330, e.g., from the one or more STAs 311, are received, e.g., by the hub 306. The one or more STAs 311 periodically collect and send wireless measurements to the hub 306. Alternatively, the one or more STAs 311 may continuously collect and send the wireless measurements to the hub 306.

In operation 404, signal pre-processing is performed on the one or more data signals 320 to produce pre-processed data signals. For example, the hub 306, may remove undesired impairments from raw measurements in the one or more data signals 320 received by the one or more STAs 311. The impairments may arise from the wireless environment, e.g., noise and interference, or from the devices in the wireless system 300, such as amplitude error caused by automatic gain control (AGC) effect.

In operation 406, one or more features are extracted using the pre-processed data signals. For example, the hub 306 may extract features related to movement of the subject 380 from the pre-processed measurements.

In operation 408, the one or more features are used, e.g., input into a detection algorithm, to determine whether a user is present in the home and identify the specific room the user is in. For example, the hub 306 may execute a detection algorithm where the multi-room presence detection result is inferred from the extracted features from each of the one or more data signals 320 from each link.

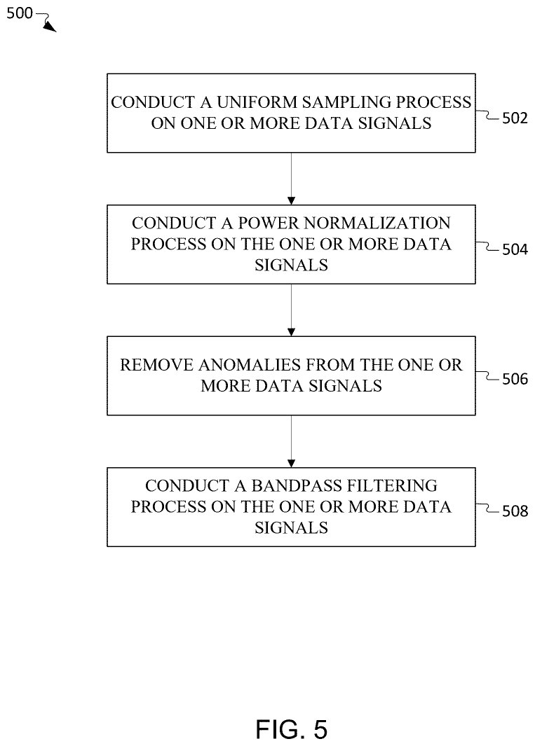

FIG. 5 illustrates a flow chart of an example signal processing method 500 for processing a data signal according to various embodiments of the present disclosure. In particular, the signal processing method 500 may be performed to pre-process the raw data signals and may be performed by the hub 306 of the wireless communication system 300 of FIG. 3A and FIG. 3B as part of the method 400 of FIG. 4, e.g., as part of the operation 404.

In operation 502, a uniform sampling process is conducted on the one or more data signals 320 received by the hub 306 from the one or more STAs 311. Due to the nature of the WiFi network measurement mechanism, the raw data signals received by the one or more STAs 311 and the hub 306 may not be evenly spaced temporally. To address this, a uniform sampling process is used to create even temporal spacing each of the one or more data signals 320. For example, the uniform sampling process may include piecewise linear interpolation. In such an example, each of the one or more data signals 320 is sampled at uniform intervals to obtain discrete data points, creating a discrete-time signal. The discrete-time signal undergoes linear interpolation where each of the sampled data points is connected with straight line segments, e.g., where the assumption is that the signal changes linearly between the sampled points, to create an interpolated signal. The interpolated signal may then be used to approximate the original data signal. Other uniform sampling processes, including impulse sampling and natural sampling methods, may be performed in this operation.

In operation 504, a power normalization process is conducted on the one or more data signals 320. The power normalization process of the operation 504 removes amplitude errors, such as the automatic gain control (AGC) effect, from the data signals. To remove the AGC effect from the one or more data signals 320, for example, the power normalization process may include dividing the CSI by the square root of its corresponding packet power, defined as the power sum across all sub-carriers. Removing the amplitude errors from the measurement signals improves accuracy of the measurement signals, e.g., the accuracy that the measured CSI change is due to the human movement rather than the automatic gain change. Other AGC gain error correction processes, including closed-loop feedback and calibration methods, may be performed in this operation.

In operation 506, anomalies are removed from the one or more data signals 320. For example, the hub 306 may remove measurement samples from the one or more data signals 320 that are significantly deviated from other samples. These deviations may be caused by strong interference or hardware errors. In one embodiment, the anomaly sample removal process may include a rule-based method. The rule-based method for anomaly removal may include removing a sample with number of peaks higher than predetermined threshold. In another embodiment, the anomaly sample removal process may include a clustering method. For example, the clustering method for the anomaly sample removal process may remove samples not belonging to a main cluster.

In operation 508, a bandpass filtering process may be conducted on the one or more data signals 320. For example, the hub 306 may reduce noise by passing the measurement signals through a bandpass filter. The bandpass filter is applied to remove low frequencies, e.g., slow varying static environment change, and high frequencies, e.g., noises, so that the frequency of the measurement signals more accurately reflects the frequencies caused by the presence of a user.

Although shown as part of the signal processing method 500, not all of operations 502-508 need be performed, e.g., one or more of operations 502-508 may be skipped, to produce “pre-processed” data signals.

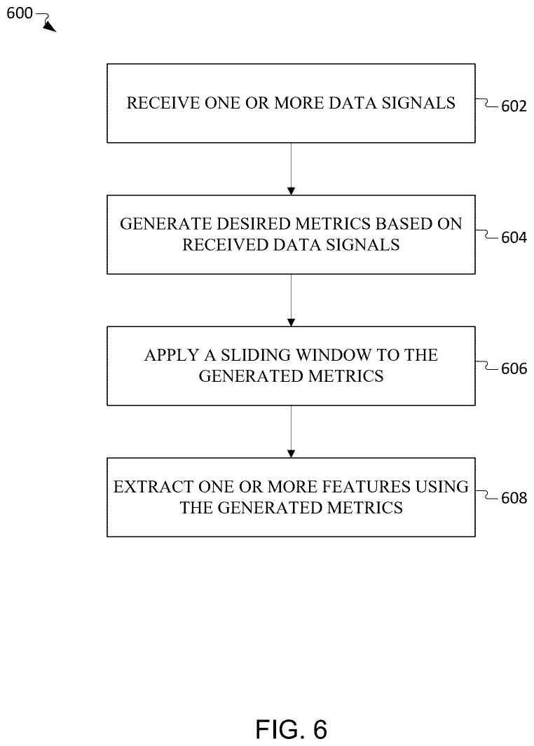

FIG. 6 illustrates a flow chart of an example method for extracting features from a data signal according to various embodiments of the present disclosure. In particular, the method 600 may be performed to extract features from one or more data signals 320 and may be performed by the hub 306 of the wireless communication system 300 of FIG. 3A and FIG. 3B as part of the method 400 of FIG. 4, e.g., as part of the operation 404.

In operation 602, the measurements are received. For example, the hub 306 may receive the measurements from the one or more STAs 311. The measurements may be raw measurements, e.g., measurements that have not been processed, or may be measurements that have undergone signal processing, e.g., pre-processed measurements generated by method 500.

In operation 604, desired metrics are generated based on the received measurements. For example, the hub 306 may generate desired metrics from the received measurements, including CSI amplitude, CSI phase, RSSI, cross-link/cross-sub-carrier/cross-antenna difference of CSI amplitude, and cross-link/cross-antenna RSSI.

In operation 606, a sliding window is applied to the generated metrics. For example, a sliding window of size T, e.g., 3 seconds, with step size S, e.g., 1 second, is applied to the calculated metrics for future statistic calculation.

In operation 608, one or more features, e.g., statistical measurements, are extracted using the generated metrics. For example, the hub 306 may generate the variance, mean, max, min, or a combination thereof from the generated metrics.

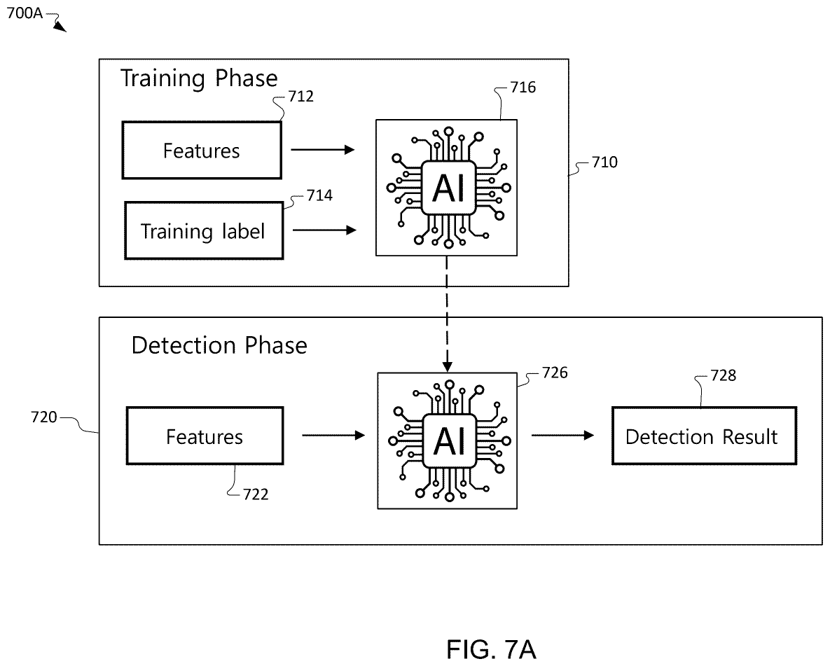

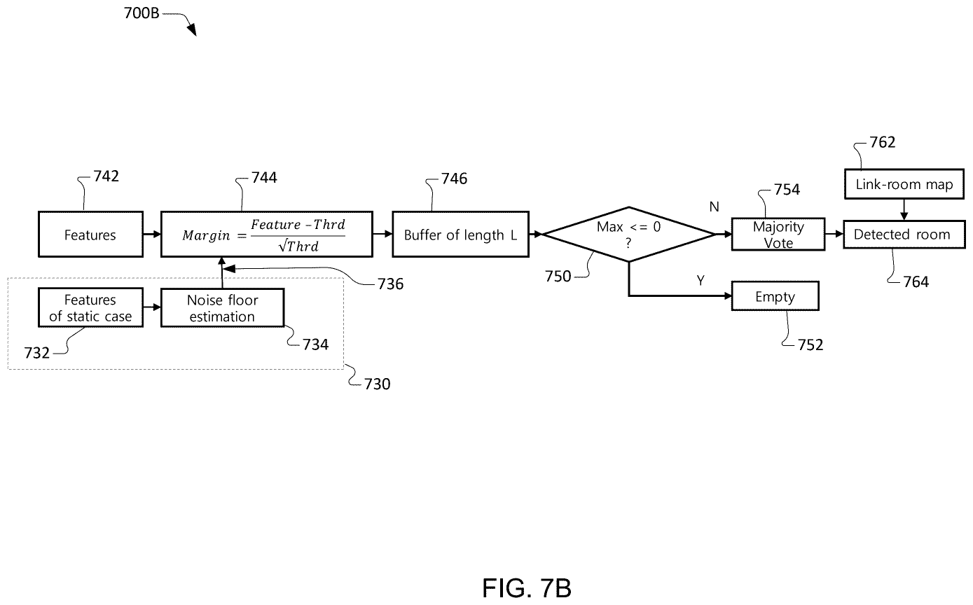

After operation 608, the generated statistics and metrics may be stored for user presence detection in a detection algorithm as discussed regarding FIGS. 7A and 7B.

FIG. 7A illustrates a flow chart of an example algorithm 700A for detecting a presence of a user using an artificial intelligence model according to various embodiments of the present disclosure. FIG. 7B illustrates a flow chart of an example algorithm 700B for detecting a presence of a user using a rule-based algorithm according to various embodiments of the present disclosure. The algorithm 700A and the algorithm 700B may be implemented, for example, by the hub 306 of the wireless system 300 of FIGS. 3A and 3B. Additionally, each of the algorithm 700A and the algorithm 700B may be implemented as part of a user presence detection method, e.g., in the operation 408 of the method 400 of FIG. 4.

Each of the algorithms 700A and 700B use extracted features of wireless measurements, e.g., features extracted using the method 600, to determine human presence in one of the rooms of a home or if all rooms are empty.

As shown in FIG. 7A, the algorithm 700A is a machine learning process that includes an AI model. Although shown with two phases, e.g., a training phase 710 and a detection phase 720, the algorithm 700A need only include the detection phase 720, e.g., the AI model may be trained using methods not described herein but commonly known to one of ordinary skill in the art.

The AI model may be any suitable neural network, including a multi-layer perceptron (MLP), recurrent neural network (RNN), and a convolutional neural network (CNN). Additionally, the AI model may be a light-size AI model, such as support vector machine (SVM). Alternatively, the AI model may be a decision tree-based classifier, e.g., a scalable, distributed gradient-boosted decision tree including XGBoost.

For training data preparation in the training phase 710, a user may walk in each room for a predetermined period, e.g., 15 second or 30 seconds, and remain static for the predetermined period. The algorithm 700A may generate training features 712 using a feature extraction method, e.g., the method 600, and training labels 714 then input the training features 712 and the training labels 714 into an AI model 716. During the training phase 710, the weights of the AI model 716 are adjusted until the AI model 716 produces acceptable output, e.g., detects the presence of a user within a desired margin of error, thus producing a trained AI model 726. The weights of the AI model 716 may be adjusted based on the extracted features using features extracted from all node-to-node links 330 and all node-to-AP links 340, such that the AI model weights are based on each link.

In the detection phase 720, the weights of the trained AI model 726 are fixed, and the trained AI model 726 is used to predict user presence with extracted features. For example, detection features 722, e.g., features that are extracted from one or more data signals collected outside of a training environment, may be extracted and input into the trained AI model 726. The trained AI model 726 then produces a detection result 728 indicating whether a user is present in a room of the home or if each of the rooms of the home are empty.

As shown in FIG. 7B, the algorithm 700B is a rule-based process and may be used to determine the presence of a user. During an initial run, the rule-based algorithm 700B may include a calibration process 730 which produces a noise floor estimation, e.g., a static case, allowing features 732 of the static case to be extracted and used for a noise floor estimation 734. During the calibration process 730, for example, a user may remain static for a predetermined period, e.g. 10 seconds, then the static case features 732 are extracted and used to calculate the noise floor estimation 734. Then, a threshold 736 used to determine empty/presence will be generated for each link, e.g., for each of the node-to-node links 330 and each of the node-to-AP links 340, based on the corresponding noise floor estimation 734 of each link. To produce an acceptable threshold 736, the threshold 736 may be a multiple of the noise floor estimation 734. For example, the threshold 736 may be a 1.1 multiple of the noise floor estimation 734.

For detection, features 742 of each link are extracted. Following feature extraction, a margin value 744 is calculated for each link as follows:

$$margin = \frac{feature - threshold}{\sqrt{threshold}} .$$

When determining the margin value 744, the numerator will be a positive value as a user approaches the link. The numerator will be non-positive when the user is static. The denominator normalizes the sensitivity of each link to similar level based on the corresponding noise floor estimation 734.

The margin value 744 is then input into a buffer 746, e.g., a look-back window, of length L. The margin values 744 in the buffer 746 are used to determine the presence detection. The use of the buffer 746 allows detection results to be more stable compared to instantaneous values of each margin value 744, preventing detection results from changing, e.g., presence detected to presence not detected and vice versa, frequently. The length L of the buffer 746 is a tunable parameter which determines the trade-off between stable detection result and detection delay, e.g., buffers 746 with larger lengths have increased detection result stability but increased detection delay. The margin values 744 in the buffer 746 are then input into a presence determination step 750. When all margin values 744 in the buffer 746 are smaller than or equal to 0, the determination step 750 produces an empty detection result 752 indicating that there is no user present, e.g., the home is empty. If there are margin values 744 in the buffer 746 that are larger than 0, the determination step 750 may use a majority vote step 754 where a majority of the margin values 744 in the buffer 746 determine, e.g., “vote”, the presence of a subject 380 in a room based on a pre-defined link-room map 762 of the house of the user. The link-room map 762 corresponds to the location of each of the one or more STAs 311 disposed in a specific room of a home and is used to determine which room, if any, a user is present. For example, the room in the link-room map 762 with most non-negative margin values 744 is selected and determined to have the presence of the user. Such a room would be indicated as a detected room in a detection result 764.

The above flow charts illustrate example methods that can be implemented in accordance with the principles of the present disclosure and various changes could be made to the methods illustrated in the flow charts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A computer-implemented method comprising:
receiving one or more data signals from at least one WiFi-node-to-Access-Point (AP) link or at least one WiFi node-to-node link;
performing a signal pre-processing process on the one or more data signals to generate one or more pre-processed data signals, performing the signal pre-processing process comprising performing a uniform sampling process, a power normalization process, an anomaly sample removal process, and a filtering process;
extracting one or more features using the one or more pre-processed data signals; and
using the one or more features to determine whether a user is present in a defined area.

2. The method of claim 1, wherein performing the power normalization process comprises removing an automatic gain control effect from the one or more data signals.

3. The method of claim 1, wherein performing the anomaly sample removal process comprises using a rule-based removal method to remove anomalies.

4. The method of claim 1, wherein performing the anomaly sample removal process comprises using a clustering removal method to remove anomalies.

5. The method of claim 1, wherein using the one or more features to determine whether the user is present in the defined area comprises using the one or more features in a machine learning process, the machine learning process using one or more features extracted from one or more data signals from the at least one WiFi node-to-AP link or the at least one WiFi node-to-node link.

6. The method of claim 1, wherein using the one or more features to determine whether the user is present in the defined area comprises performing a rule-based process using the one or more features.

7. The method of claim 6, wherein performing the rule-based process comprises calculating margin values and determining a presence of the user based on the calculated margin values and a buffer.

8. A presence detection system, comprising:
one or more transceivers; and
a hub comprising a processor, the processor configured to cause the hub to:
receive one or more data signals from at least one WiFi-node-to-Access-Point (AP) link or at least one WiFi-node-to-node link;
perform a signal pre-processing process on the one or more data signals to generate one or more pre-processed data signals, performing the signal pre-processing process comprising performing a uniform sampling process, a power normalization process, an anomaly sample removal process, and a filtering process;
extract one or more features using the one or more pre-processed data signals; and
use the one or more features to determine whether a user is present in a defined area.

9. The presence detection system of claim 8, wherein the processor, to perform the power normalization process, is further configured cause the hub to remove an automatic gain control effect from the one or more data signals.

10. The presence detection system of claim 8, wherein the processor, to perform the anomaly sample removal process, is further configured cause the hub to use a rule-based removal method to remove anomalies.

11. The presence detection system of claim 8, wherein the processor, to perform the anomaly sample removal process, is further configured cause the hub to use a clustering removal method to remove anomalies.

12. The presence detection system of claim 8, wherein the processor, to use the one or more features to determine whether a user is present in the defined area, is further configured cause the hub to use the one or more features in a machine learning process, the machine learning process using one or more features extracted from one or more data signals from the at least one WiFi node-to-AP link or the at least one WiFi node-to-node link.

13. The presence detection system of claim 8, wherein the processor, to use the one or more features to determine whether a user is present in the defined area, is further configured cause the hub to perform a rule-based process using the one or more features.

14. The presence detection system of claim 13, wherein the processor, to perform the rule-based process, is further configured cause the hub to calculate margin values and determine a presence of the user based on the calculated margin values and a buffer.

15. A non-transitory computer-readable medium comprising program code, that when executed by at least one processor of an electronic device, causes the electronic device to:
receive one or more data signals from at least one WiFi-node-to-Access-Point (AP) link or at least one WiFi-node-to-node link;
perform a signal pre-processing process on the one or more data signals to generate one or more pre-processed data signals, performing the signal pre-processing process comprising performing a uniform sampling process, a power normalization process, an anomaly sample removal process, and a filtering process;
extract one or more features using the one or more pre-processed data signals; and
use the one or more features to determine whether a user is present in a defined area.

16. The non-transitory computer-readable medium of claim 15, wherein the program code, that when executed by the at least one processor, causes the electronic device to perform the power normalization process, comprises program code, that when executed by the at least one processor, causes the electronic device to remove an automatic gain control effect from the one or more data signals.

17. The non-transitory computer-readable medium of claim 15, wherein the program code, that when executed by the at least one processor, causes the electronic device to perform the anomaly sample removal process, comprises program code, that when executed by the at least one processor, causes the electronic device to use a rule-based removal method to remove anomalies.

18. The non-transitory computer-readable medium of claim 15, wherein the program code, that when executed by the at least one processor, causes the electronic device to perform the anomaly sample removal process, comprises program code, that when executed by the at least one processor, causes the electronic device to use a clustering removal method to remove anomalies.

19. The non-transitory computer-readable medium of claim 15, wherein the program code, that when executed by the at least one processor, causes the electronic device to use the one or more features to determine whether the user is present in the defined area, comprises program code, that when executed by the at least one processor, causes the electronic device to use the one or more features in a machine learning process that uses the one or more features extracted from one or more data signals from the at least one WiFi node-to-AP link or the at least one WiFi node-to-node link.

20. The non-transitory computer-readable medium of claim 15, wherein the program code, that when executed by the at least one processor, causes the electronic device to use the one or more features to use the one or more features to determine whether a user is present in the defined area, comprises program code, that when executed by the at least one processor, causes the electronic device to perform a rule-based process that includes calculating margin values and determining a presence of the user based on the calculated margin values and a buffer.
